(19) United States
(12) Patent Application Publication
(10) Pub. No.: US 2003/0127560 A1
(43) Pub. Date: Jul. 10, 2003

(54) Flat balloon

(76) Inventor: Alexander Liss, New York, NY (US)

Correspondence Address: ALEXANDER LISS, 333 E 66 ST APT 5C, NEW YORK, NY, 10021, US

(21) Appl. No.: 10/364,711

(22) Filed: Feb. 11, 2003

Related U.S. Application Data
(63) Continuation-in-part of application No. 09/681,769, filed on Jun. 1, 2001, now abandoned.

(51) Int. Cl. B64B 1/02; B64B 1/06

(52) U.S. Cl. 244/30

(57) ABSTRACT

A Flat Balloon—a set of partially filled with the lighter-than-air gas gas-bags held together with a net, which has tied-in in-flight-horizontal tubes, keeping an entire construction in-flight-vertically-flat but foldable, with control ropes attached to the net, which allow spreading or folding of the Flat Balloon, while gas is in it, and cylindrical nets filed with rigid elements inside gas-bags, which prevent the gas-bags from collapsing during pumping the gas out of the gas-bags.

### CROSS REFERENCE TO RELATED APPLICATIONS

This is a continuation-in-part of the application:

Ser. No. 09/681,769 Art Unit 3644, A.Liss, Flat Balloon

### BACKGROUND OF THE INVENTION

Different modifications of lighter-than-air flying devices—balloons, blimps, dirigibles or airships and their applications are described in following U.S. patents:

U.S. Pat. No. 6,196,498 Eichstedt, et al. Mar. 6, 2001

U.S. Pat. No. 6,019,311 Thyen Feb. 1, 2000

U.S. Pat. No. 5,931,413 Hayashi Aug. 3, 1999

U.S. Pat. No. 5,823,468 Bothe Oct. 20, 1998

U.S. Pat. No. 5,697,579 Hayashi Dec. 16, 1997

U.S. Pat. No. 5,143,322 Mason Sep. 1, 1992

U.S. Pat. No. 5,005,783 Taylor Apr. 9, 1991

U.S. Pat. No. 4,695,012 Lindenbaum Sep. 22, 1987

U.S. Pat. No. 4,497,272 Veazey Feb. 5, 1985

U.S. Pat. No. 4,012,016 Davenport Mar. 15, 1977

Wind carries lighter-than-air flying devices in its direction. In dirigibles, blimps and other similar devices with a rigid construction, their shape is chosen to minimize this effect. Balloons have flexible construction, and in-flight, their shape is defined by tendency of lighter-than-air gas to accumulate at the top of the balloon, leaving bottom of it empty and often collapsed. When a balloon rises to higher altitudes, the gas in its gas-bag expands, fills the entire gas-bag and forces the gas-bag to take a form close to sphere.

In-flight, control of movement of these flying devices is done with release or pumping of the lighter-than-air gas from its gas-bags to reduce buoyancy of it and with propellers moved by engines. Propellers and engines are usually attached to a flying device's gondola.

Often ropes are attached to these flying devices to assist in their lending and anchoring.

Rigid flying lighter-than-air devices require hangars for their storage and protection from bad weather and especially from strong winds. For storage of flexible devices, the gas is released or pumped out them and their cover is folded.

### BRIEF SUMMARY OF THE INVENTION

The invention is a Flat Balloon—a set of gas-bags partially filled with a lighter-than-air gas and held together by a cover (for example a net), which has rigid elements (for example tied-in tubes) keeping an entire construction flat, but flexible. The cover with rigid elements should be flexible—it should allow folding of the Flat Balloon. The Flat Balloon can be spread over a field or folded without removing the lighter-than-air gas from it.

Ropes are attached to its cover. In addition to assistance in lending and anchoring, these ropes are used to spread the Flat Balloon and to fold it.

The gas can be pumped out of gas-bags to reduce buoyancy of the Flat Balloon. To support this pumping of gas, there is a net inside a gas-bag. It has a form of cylinder and it is filled with rigid elements, for example hollow balls with holes in them. One end of this net is attached to the gas-bag's top and the other end is attached to its bottom, where a gas pump is attached. During pumping gas out the gas-bag, this construction prevents a gas-bag from collapsing on itself and on an opening of a pump in the gas-bag. Obviously, for pumping gas out, the access of external air into a gas-bag should be prevented.

A gondola with propellers and engines can be attached to the Flat Balloon. Engines move propellers attached to the gondola and the direction of the force exerted by propellers can be changed. The Flat Balloon movement in the air is controlled with coordinated positioning of its broad side and its propellers at proper angles to the wind.

The Flat Balloon can be used for advertisement, entertainment (toys), as a sail of a boat or with a gondola for transportation.

### BRIEF DESCRIPTION OF THE SEVERAL VIEWS OF THE DRAWING

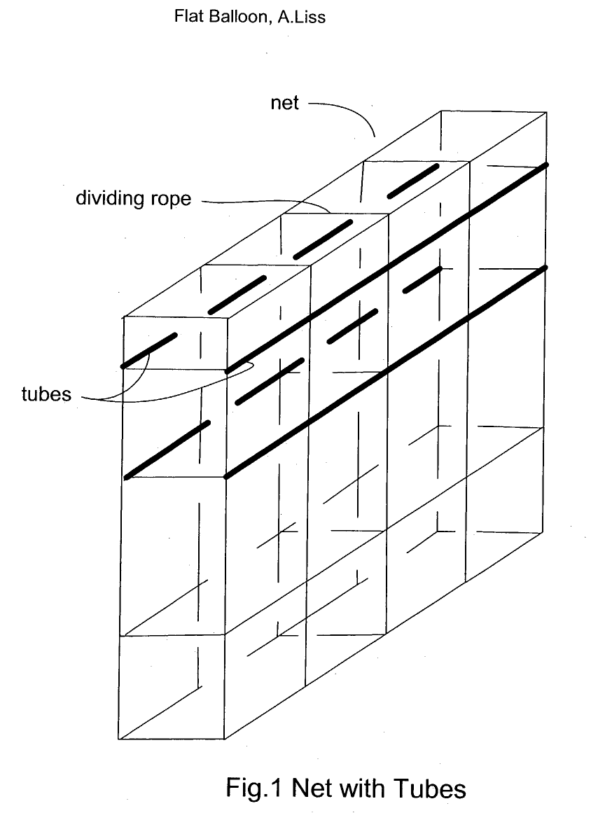

“FIG. 1 Net with Tubes.” shows an example of a main cover of the Flat Balloon, which holds and “squashes” a set of gas-bags; it is a net with tied-in in-flight-horizontal tubes.

### DETAILED DESCRIPTION OF THE INVENTION

The invention is a Flat Balloon, where a special cover holds one or a set of gas-bags and squashes them to give an entire construction a vertically flat shape in-flight. Unlike a blimp, the Flat Balloon has its gas-bags only partially filled with the lighter-than-air gas.

This cover should have some rigid elements. It is sufficient to have rigid tubes in it, which are horizontal, when the Flat Balloon is in-flight. These rigid elements should not prevent the Flat Balloon from being folded. Unlike a dirigible the Flat Balloon has a semi-rigid cover.

To minimize its weight it is preferable to have a net as a cover and rigid tubes are tied in it as its rigid elements. If there are a few gas-bags in the Flat Balloon, than this net can be amended with a few tied-in ropes separating these bags from each other and limiting their movement inside this cover.

To maximize “squashing” efficiency of such net with tubes, tubes should be tied together with ropes in pairs; in-flight, a tube of the Flat Balloon should have its pair on an opposite side. Tubes of this cover do not need to go all width of the broad side of the Flat Balloon.

Being properly anchored, such device automatically turns to minimize the force of wind exerted on it.

Properly attached to a boat it can serve as a sail.

In combination with engines and propellers it gives higher degree of in-flight control than existing lighter-than-air flying devices. An angle between its broad side and a direction of wind defines a direction and strength of force of wind exerted on it. A pair of propellers can be used to turn the Flat Balloon and to control this angle. Propellers independently exert an additional moving force, which strength and angle to the direction of the wind can be controlled. These independently controlled two forces allow fine control of the direction of movement of the Flat Balloon. The control is similar to the control of a sailboat, where two forces (a force of wind acting on a sail and a force of resistance of water to a sideway movement of the boat) are used to move the boat in a desired direction.

In-flight, a balloon of a vertically flat shape provides more surfaces usable for advertisement, than a dirigible or a balloon of a similar volume.

On the ground, a partially filled with the lighter-than-air gas balloon of a flat shape has additional advantages. When it is anchored, it can be folded or spread over a field without releasing or pumping out the lighter-than-air gas. Thus, it can be protected from a strong wind on the ground or it can fit in a relatively small building.

To assist spreading and folding, the cover with rigid elements, which squashes gas-bags, should have ropes attached to it. These ropes should be attached in a few places of this cover, preferably to its rigid elements. Ropes, which are used for lending and initial anchoring, should reach down at least to the in-flight-bottom of Flat Balloon. Other ropes can be long or short depending on a procedure of spreading or folding of the Flat Balloon.

The gas can be pumped out of a gas-bag to reduce buoyancy of the Flat Balloon. However, a gas-bag have a tendency to collapse on the opening of the pump, while the gas is pumped out. To prevent this, there are gas-ways inside gas-bags. Such gas-way is a net of cylindrical form inside a gas-bag filled with lightweight rigid elements, for example hollow balls with holes. One end of it is attached to a part of gas-bag, which is its top in-flight, and the other end coincides with an opening of a pump, which is at its bottom in-flight.

In a preferred implementation, there is an elongated gondola connected to the Flat Balloon's net (main cover) with its long side along the broad side of the Flat Balloon. Inside this net there is a few gas-bags with openings turned to the gondola placed one after the other along the broad side of the Flat Balloon. Two engines with propellers are connected to the gondola at its narrow ends—one engine with propeller at each narrow end. Direction of rotation of propellers can be controlled—in-flight, their axes of rotation can swing independently in a horizontal plane.

These two propellers allow positioning of the broad side of the Flat Balloon to a wind and exerting a force additional to a force of wind to adjust the direction of movement of the Flat Balloon.

When a direction of rotation of propellers can be controlled in a vertical plane in-flight, the engines can be used to assist in takeoff and lending.

Two long ropes are attached to the in-flight-top of the Flat Balloon's net—one on each side of its broad side. They reach down from the in-flight-top of the Flat Balloon to the place in-flight-beneath the gondola to be used for lending, anchoring and first steps of folding. Two shorter ropes are attached to the net of the Flat Balloon at the in-flight-middle of the Flat Balloon. They also reach down to the place in-flight-beneath the gondola to be used for following steps of folding of the Flat Balloon.

The net is a main cover of the Flat Balloon. In addition there are two special covers—an internal and an external cover.

The internal cover is placed underneath the net and above gas-bags; it protects gas-bags from tear.

The external cover with holes for control ropes is placed above the net with control ropes pooled through these holes; it supplies a continuous surface convenient for advertisement.

The Flat Balloon has two distinct broad sides, one of which can be consistently turned to the sun. One broad side of a Flat Balloon is of a bright color and the other broad side is of a dark color—the coloring is done on the external cover, if it is present. Turning dark side of the Flat Balloon to the sun causes its gas to heat-up and increases Flat Balloon's buoyancy. Turning its bright side to the sun causes sunrays to be reflected and temperature of the Flat Balloon gas to get in line with outside temperature; this usually decreases Flat Balloon's buoyancy.

In the gondola there is a tank with the compressed lighter-than-air gas and a pump connected to the gas-bags. This pump is used to pump the gas out of the gas-bags and into them as needed.

In each gas-bag there is a cylindrical net, one end of it is attached to the place, which is in-flight-top of a gas-bag and the other to the opening of the pump in the gas-bag. This net is filled with lightweight hollow plastic balls with holes in them.

On the ground, the Flat Balloon is stored with lighter-than-air gas in it in a spread and folded form. At lending, long ropes are used to pin down a part of the Flat Balloon, which is an in-flight-top, to the ground. As a consequence, the lighter-than-air gas moves to the part, which is an in-flight-middle of the Flat Balloon. The second pair of ropes is used to pin down to the ground the in-flight-middle of the Flat Balloon. As a consequence, the lighter-than-air gas is divided in two parts and moves to two places of the Flat Balloon—one is between the in-flight-middle of the Flat Balloon and its in-flight-top and the other is between the in-flight-middle and the in-flight-bottom. As a next step, the Flat Balloon is spread on the ground as much as lighter-than-air gas in it allows doing this.

I claim:

1. A lighter-than-air flying device—a Flat Balloon, which consists of one or a few gas-bags partially filled with the lighter-than-air gas and a partially rigid foldable cover with rigid elements in it holding the gas-bags together; rigid elements of the cover cause the Flat Balloon to have an in-flight-vertically-flat shape.

2. The Flat Balloon of the claim 1, where ropes are attached to the cover, which can be used to spread the Flat Balloon or to fold it, while the lighter-than-air gas is in its gas-bags.

3. The Flat Balloon of the claim 1, where a gondola with engines and propellers is attached to its cover and directions of axes of propellers can be changed to change the direction of forces exerted by propellers on the Flat Balloon.

4. A method of the claim 3, where the direction of flight of the Flat Balloon is adjusted by setting the broad side of the Flat Balloon at a proper angle to the wind and exerting forces with propellers at proper angles and strength.

5. The Flat Balloon of the claim 2, where an external cover with holes for ropes in it is placed over its main cover with ropes pulled through these holes.

6. The Flat Balloon of the claim 1, where an internal cover is placed underneath the main cover and over its gas-bags.

7. The Flat Balloon of the claim 1, where one of its broad sides is of a dark color and the other of a bright color.

8. The method of the claim 7, where the bright side of it is turned to the sun to keep its gas cool or the dark side of it is turned to the sun keep its gas worm.

9. The Flat Balloon of the claim 1, where the cover is a net with tubes tied in it, as its rigid elements, that tubes are horizontal in-flight.

10. The method of the claim 1, where the in-flight-vertically-flat sides of the Flat Balloon are used to place advertisement materials.

11. The method of the claim 1, where the Flat Balloon is attached to a boat and used as a sail.

12. In a gas-bag filled with the lighter-than-air gas with a pump attached to its in-flight-bottom to pump gas out, a cylindrical net filed with rigid elements, one end of which is attached to the opening of the pump and the other end of it is attached to the in-flight-top of the gas-bag.
